(19) United States
(12) Patent Application Publication
(10) Pub. No.: US 2008/0012748 A1
(43) Pub. Date: Jan. 17, 2008

(54) APPARATUS AND METHOD FOR PERFORMING CALIBRATION IN A COMMUNICATION SYSTEM

(75) Inventor: Cheol-Woo AHN, Suwon-si (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/776,026

(22) Filed: Jul. 11, 2007

(30) Foreign Application Priority Data
Jul. 11, 2006 (KR) 2006-64949

(51) Int. Cl. G01S 7/40; G01S 13/00

(52) U.S. Cl. 342/21; 342/174

(57) ABSTRACT

A calibration apparatus and method in a communication system are provided. In the apparatus and method, baseband reference signals are generated for signal transmission paths, upconverted to RF signals, and downconverted to a baseband signal after coupling and combining, and transmission calibration vectors are acquired using the baseband signal, and a reference signal is generated, upconverted to an RF signal, distributed to signal reception paths, coupled, and downconverted to baseband signals, and reception calibration vectors are acquired using the baseband signals. Accordingly, the apparatus and method perform calibration without the need for using additional Tx and Rx hardware in a communication system which minimizes system complexity.

### CROSS-REFERENCE TO RELATED PATENT APPLICATION

This application claims the benefit under 35 U.S.C. § 119(a) of a Korean Patent Application filed in the Korean Intellectual Property Office on Jul. 11, 2006 and assigned Serial No. 2006-64949, the entire disclosure of which is hereby incorporated by reference.

### BACKGROUND OF THE INVENTION

1. Field of the Invention

The present invention generally relates to a communication system. More particularly, the present invention relates to an apparatus and method for performing calibration for signal compensation in a communication system using a smart antenna.

2. Description of the Related Art

In a wireless communication system, a smart antenna steers a signal to any of directions of interest by controlling the phases of antennas in an antenna array. As the smart antenna emits an independent beam between a transmitter and a receiver in a manner that maximizes propagation to a desired direction and minimizes propagation to other directions, it significantly attenuates the noise of a received signal. Therefore, the use of the smart antenna offers the benefits of an increased communication quality, a maximal communication capacity, and an increased battery life attributed to low-power calls in the wireless communication system.

Multiple antennas, for example, are adopted for the smart antenna and a beamforming coefficient is applied to a carrier signal input to each antenna, for beamforming. To do so, the amplitudes of carrier signals should be controlled and the amplitude control requires signal compensation for paths running through Transmitting (Tx) modules and Receiving (Rx) modules. This is called calibration.

Without appropriate calibration, an inappropriate beamforming coefficient is applied to a carrier signal input to each antenna. The resulting carrier signals have errors in their phases and amplitudes, thereby making normal beamforming impossible.

In calibration, a calibration signal undergoes a phase variation in the course of a Tx path to an antenna and an Rx path from a coupler. Let the phase variation from the Tx path be denoted by e^{jθ}^{_{cal}} and the phase variation from the Rx path (i.e. feedback path) be denoted by e^{jθ}^{_{feedback}}.

A reference signal C(t) transmitted for the calibration experiences phase variations in the Tx and Rx paths, thus becoming C(t)e^{jθ}^{_{cal}}e^{jθ}^{_{feedback}}. For N antennas, the reference signal C(t) is received from N paths. The received reference signal from each path is expressed as

$$\begin{matrix}{C}_{1} ( t ) = {α}_{1} C ( t ) {e}^{j {θ}_{1 , cal}} {e}^{j {θ}_{feedback}} \\ {C}_{2} ( t ) = {α}_{2} C ( t ) {e}^{j {θ}_{2 , cal}} {e}^{j {θ}_{feedback}} \\ ⋮ \\ {C}_{N} ( t ) = {α}_{N} C ( t ) {e}^{j {θ}_{N , cal}} {e}^{j {θ}_{feedback}}\end{matrix} \qquad ( 1 )$$

where C_{N}(t) denotes the received reference signal from an N^{th} path and α_{N} denotes a signal attenuation in the N^{th} path.

The received signals described in Equation (1) have passed through couplers connected to the respective antennas, thus assuming the characteristics of the couplers, R_{coupler} which should be eliminated.

In order to match the relative phases of the N antennas, for beamforming, a calibration vector is applied to each antenna, computed by

$${w}_{c , 1} = conj [ \frac{{C}_{1} ( t ) / {R}_{coupler 1}}{C ( t )} ] \\ {w}_{c , 2} = conj [ \frac{{C}_{2} ( t ) / {R}_{coupler 2}}{C ( t )} ] \\ {w}_{c , N} = conj [ \frac{{C}_{N} ( t ) / {R}_{coupler N}}{C ( t )} ] \qquad ( 2 )$$

If the beamforming coefficients applied to the antennas for beamforming are W_{b1}, W_{b2}, . . . , W_{bN}, they become W_{b1}w_{c1}, W_{b2}w_{c2}, . . . , W_{bN}w_{cN} after compensation of the hardware paths with the above calibration vectors.

Typically, a reference signal injection method is used for calibration. As implied from its title, the reference signal injection method uses a predetermined reference signal for the calibration. Although absolute compensation values can be calculated for the Tx and Rx paths by means of the reference signal, Tx and Rx hardware is additionally required for transmitting and receiving the reference signal.

This means that the smart antenna communication system needs Tx and Rx paths in which the reference signal is transmitted and received for calibration, in addition to existing signal Tx and Rx paths. As a consequence, system complexity is increased.

### SUMMARY OF THE INVENTION

An aspect of the present invention is to address at least the above mentioned problems and/or disadvantages and to provide at least the advantages described below. Accordingly, an aspect of exemplary embodiments of the present invention is to provide an apparatus and method for performing calibration in a communication system.

Another aspect of exemplary embodiments of the present invention is to provide an apparatus and method for performing calibration without the need for using additional Tx and Rx hardware in a communication system.

A further aspect of exemplary embodiments of the present invention is to provide an apparatus and method for performing calibration so as to minimize system complexity in a communication system.

In accordance with an aspect of the present invention, a calibration method in a communication system is provided. In the calibration method, baseband reference signals are generated for signal transmission paths, upconverted to RF signals, coupled, combined, and downconverted, and transmission calibration vectors are acquired using the baseband signal.

In accordance with another aspect of the present invention, a calibration method in a communication system is provided. In the calibration method, a reference signal is generated, upconverted to an RF signal, distributed to signal reception paths, coupled, and downconverted to baseband signals, and reception calibration vectors are acquired using the baseband signals.

In accordance with a further aspect of the present invention, a calibration method in a communication system is provided. In the calibration method, first, second and third calibration paths are formed, first, second and third calibration signals for use in calibration are acquired by transmitting reference signals in the first, second and third calibration paths, and calibration vectors are acquired using the first, second and third calibration signals.

In accordance with still another aspect of the present invention, a calibration apparatus in a communication system is provided. The calibration apparatus includes a baseband module for generating reference signals for transmission paths and for acquiring calibration vectors using the reference signals received after transmitting the reference signals in the transmission paths, an RF module for radio-processing the reference signals and for providing the processed reference signals to the baseband module, and a calibration path controller for controlling transmission and reception paths of the reference signals.

In accordance with still a further aspect of the present invention, a calibration apparatus in a communication system is provided. The calibration apparatus includes a reference signal generator for generating reference signals for signal transmission paths, a plurality of transmission modules for upconverting the reference signals to RF signals for the signal transmission paths, a plurality of couplers for coupling the RF signals, a combiner and distributor for combining the coupled signals, a first reception module for downconverting the combined signal to a baseband signal, and a calibrator for acquiring transmission calibration vectors using the baseband signal.

In accordance with yet another aspect of the present invention, a calibration apparatus in a communication system is provided. The calibration apparatus includes a reference signal generator for generating a reference signal, a first transmission module for upconverting the reference signal to an RF signal, a first switch for switching the RF signal, a combiner and distributor for distributing the switched signal to signal reception paths, a plurality of reception modules for downconverting the distributed signals to baseband signals, and a calibrator for acquiring reception calibration vectors using the baseband signals.

In accordance with yet a further aspect of the present invention, a calibration apparatus in a communication system is provided. The calibration apparatus includes a reference signal generator for generating a first reference signal, a first transmission module for upconverting the first reference signal to an RF signal, a first coupler for coupling the RF signal, a combiner and distributor for distributing the coupled signal to reception modules except for a first reception module sharing the same antenna with the first transmission module, a plurality of couplers for coupling the distributed signals, wherein the reception modules downconvert the coupled signals to the baseband signals, and a calibrator for acquiring a first calibration signal using the baseband signals.

### BRIEF DESCRIPTION OF THE DRAWINGS

The above and other aspects, features and advantages of exemplary embodiments of the present invention will be more apparent from the following detailed description taken in conjunction with the accompanying drawings, in which:

FIG. 1 illustrates a calibration apparatus according to an exemplary embodiment of the present invention;

FIG. 2 illustrates a calibration apparatus with additional couplers according to an exemplary embodiment of the present invention;

FIG. 3A illustrates Tx calibration paths according to an exemplary embodiment of the present invention;

FIG. 3B illustrates Rx calibration paths according to an exemplary embodiment of the present invention;

FIG. 4 is a flowchart illustrating a Tx calibration operation according to an exemplary embodiment of the present invention;

FIG. 5 is a flowchart illustrating an Rx calibration operation according to an exemplary embodiment of the present invention;

FIG. 6 is a flowchart illustrating a calibration operation according to an exemplary embodiment of the present invention;

FIG. 7 illustrates a calibration apparatus according to another exemplary embodiment of the present invention;

FIGS. 8A, 8B and 8C illustrate calibration paths according to another exemplary embodiment of the present invention;

FIGS. 9A, 9B and 9C are flowcharts illustrating reference signal processing in the course of the calibration paths according to another exemplary embodiment of the present invention; and

FIG. 10 is a flowchart illustrating a calibration operation according to another exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a calibration apparatus and method for compensating Transmitting (Tx) and Receiving (Rx) hardware paths in a communication system using a smart antenna. For this purpose, exemplary embodiments of the present invention also provide an apparatus and method for performing Tx calibration and Rx calibration by establishing calibration paths and transmitting and receiving a reference signal in the calibration paths in a communication system. An exemplary calibration apparatus transmits/receives the reference signal in a single reference Tx/Rx path, controls Tx/Rx calibration paths of the reference signal by controlling Transmit Control Blocks (TCBs), switches, and a combiner/distributor, and performs calibration using signals received from the calibration paths.

In the present invention, a calibration apparatus and method may be considered in two ways.

An exemplary embodiment of the present invention will be described in the context of a time-division communication system, by way of example. In view of the nature of the time-division communication system that uses the same frequency for transmission and reception unlike a frequency-division communication system, a single antenna suffices for signal transmission and reception because the same beam shape is used for transmission and reception.

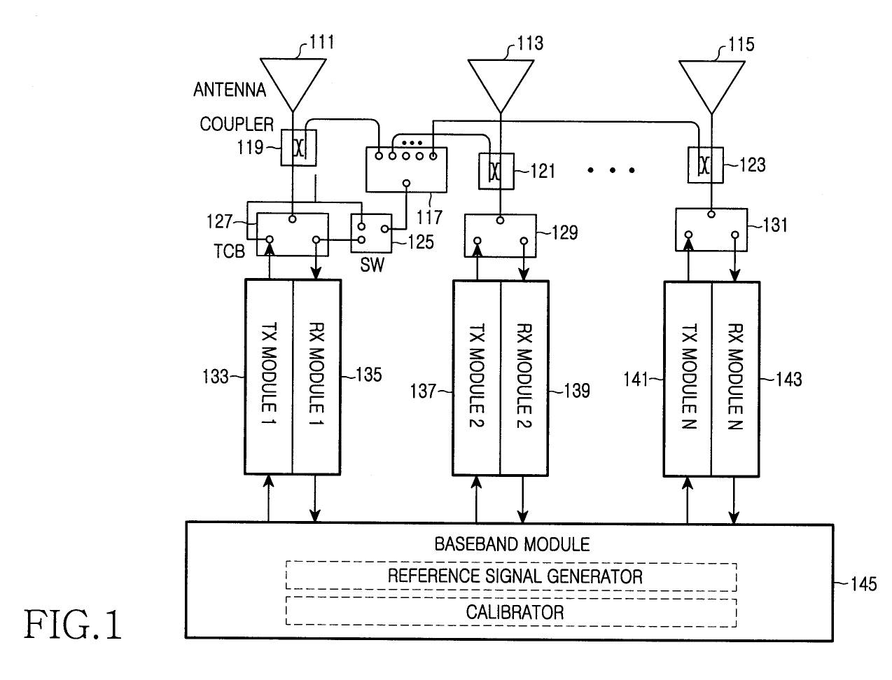

FIG. 1 illustrates the structure of a calibration apparatus according to an exemplary embodiment of the present invention.

Referring to FIG. 1, the calibration apparatus includes antennas 111, 113 and 115, couplers 119, 121 and 123, TCBs 127, 129 and 131, Tx modules 133, 137 and 141, Rx modules 135, 139 and 143, a baseband module 145, a combiner/distributor 117, and a switch 125.

The baseband module 145 includes a reference signal generator for generating a reference signal and a calibrator for performing calibration using a signal received from each path.

The calibrator receives a signal from each path and extracts a calibration vector for the path. It compensates the Tx/Rx hardware paths by applying the calibration vectors to beamforming coefficients used for beamforming. The calibrator may perform calibration continuously during signal transmission/reception, or during intervals if hardware performance does not change fast.

The Tx modules 133, 137 and 141 upconvert signals received from the baseband module 145. The Rx modules 135, 139 and 143 downconvert signals received from the TCBs 127, 129 and 131 and provide the downconverted signals to the baseband module 145.

The TCBs 127, 129 and 131 output the signals received from the Tx modules 133, 137 and 141 to the couplers 119, 121 and 123, respectively, and output signals received through the antennas 111, 113 and 115 to the Rx modules 135, 139 and 143. The TCBs 127, 129 and 131 include Tx ports connected to the Tx modules 133, 137 and 141, Rx ports connected to the Rx modules 135, 139 and 143, and antenna ports connected to the antennas 111, 113 and 115. Accordingly, the TCBs 127, 129 and 131 operate in Tx mode when transmitting signals and in Rx mode when receiving signals.

The couplers 119, 121 and 123, which are positioned between the TCBs 127, 129 and 131 and the antennas 111, 113 and 115, connect the TCBs 127, 129 and 131 to the antennas 111, 113 and 115. The couplers 119, 121 and 123 each have a coupling port for extracting or coupling a signal with a coupling value from or to ports for receiving and outputting a traffic signal. In accordance with an exemplary embodiment of the present invention, the couplers 119, 121 and 123 couple reference signals input to the antennas 111, 113 and 115 to the combiner/distributor 117, or provide reference signals received from the combiner/distributor 117 to the TCB 127, for calibration.

The antennas 111, 113 and 115 transmit or receive signals.

An exemplary embodiment of the present invention is characterized in that a reference signal is transmitted/received in a single reference Tx/Rx path, for calibration. By way of example, the reference Tx/Rx path runs through a first Tx module 133 and a first Rx module 135 connected to the baseband module 145.

The combiner/distributor 117 combines signals received from the Tx modules 133, 137 and 141 through the TCBs 127, 129 and 131 and the couplers 119, 121 and 123, or distributes a signal received from the first Tx module 133. The combiner/distributor 117 can be a switch.

The switch 125 connected to the combiner/distributor 117 is connected to the first TCB 127 via a first Tx port and a first Rx port of the TCB 127. Thus, the switch 125 switches the combiner/distributor 117 to the first Tx port or the first Rx port of the TCB 127.

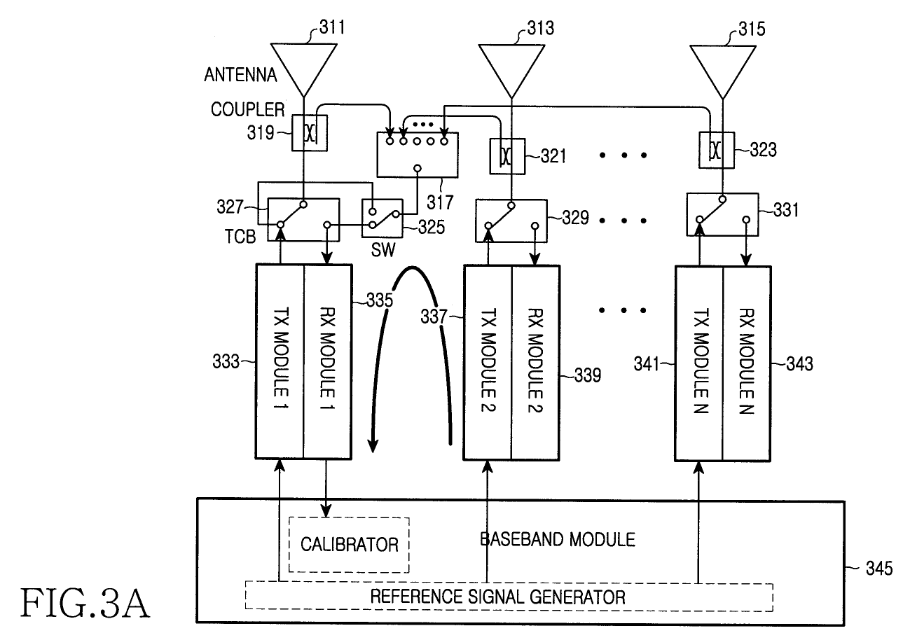

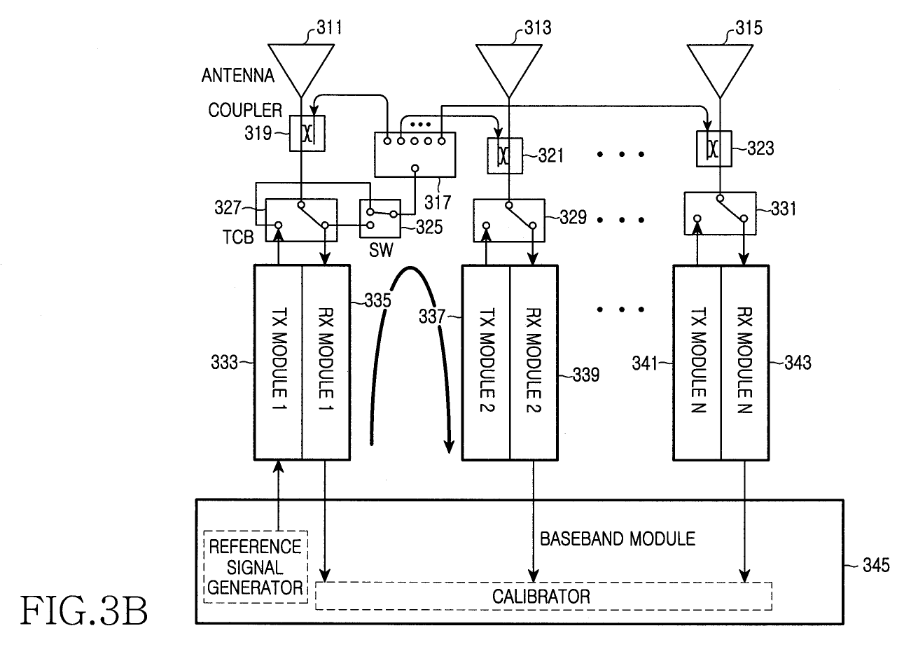

A Tx calibration operation for calibrating Tx paths and an Rx calibration operation for calibrating Rx paths in the above-described exemplary calibration apparatus will be described later with reference to FIGS. 3A and 3B.

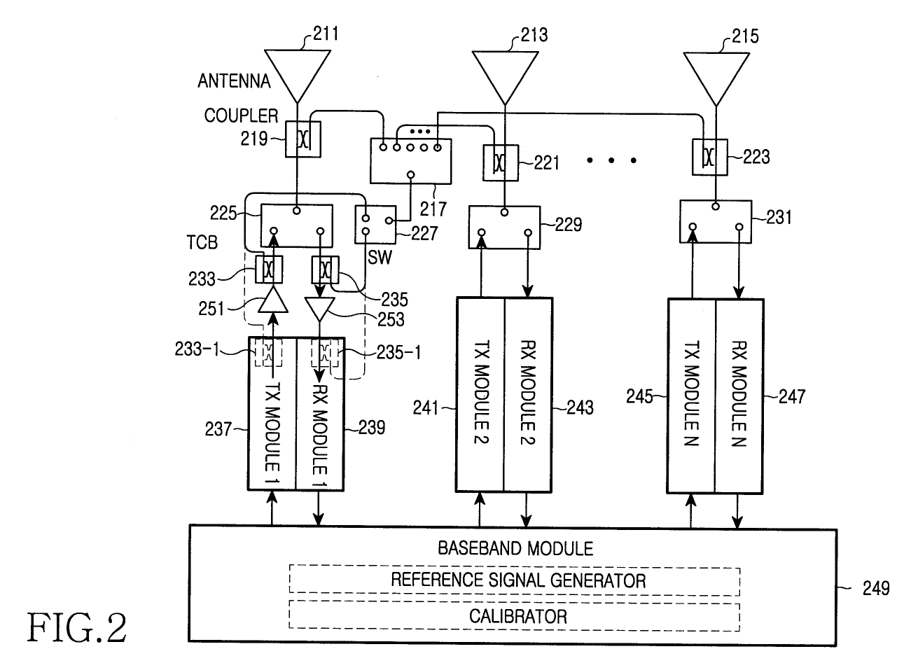

FIG. 2 illustrates a calibration apparatus with additional couplers according to an exemplary embodiment of the present invention.

Referring to FIG. 2, the calibration apparatus includes antennas 211, 213 and 215, couplers 219, 221 and 223, TCBs 225, 229 and 231, Tx modules 237, 241 and 245, Rx modules 239, 243 and 247, a baseband module 249, a combiner/distributor 217, a switch 227, a Tx coupler 233, an RX coupler 235, a first amplifier 251, and a second amplifier 253.

The calibration apparatus is configured by adding the Tx coupler 233 and the Rx coupler 235 to the calibration apparatus illustrated in FIG. 1. While not shown in FIG. 1, the first and second amplifiers 251 and 253 exist in the first and second Tx modules 133 and 135 illustrated in FIG. 1. They are shown in FIG. 2 for the purpose of clarifying the positions of the couplers 233 and 235. Herein, the Tx and Rx couplers 233 and 235 are provided in paths running through a first Tx module 237 and a first Rx module 239. Hence, a description of the components illustrated in FIG. 1 will not be provided redundantly herein.

Accordingly, the switch 227 switches signals between the Tx and Rx couplers 233 and 235 and the combiner/distributor 217, instead of switching signals between the first Tx and Rx ports and the combiner/distributor 117 as illustrated in FIG. 1.

The combiner/distributor 217 distributes a signal received from the Tx coupler 233, and combines input signals and outputs the combined signal to the Rx coupler 235. A switch can be used as the combiner/distributor 217.

In an exemplary embodiment, the Tx coupler 233 and the Rx coupler 235 can be incorporated in the first Tx module 237 and the first Rx module 239, respectively. In this case, the Tx coupler and the Rx coupler are denoted by reference numerals 233-1 and 235-1, respectively in FIG. 2. Thus the Tx coupler 233-1 can be positioned at the input end of the first amplifier 251 and the Rx coupler 235-1 can be positioned at the output end of the second amplifier 253. While the calibration apparatus with the additional couplers 233 and 235 has been derived from that illustrated in FIG. 1, other exemplary embodiments can further be contemplated by positioning the couplers 233 and 235 (or 233-1 and 235-1) in the reference Tx and Rx paths.

The above calibration apparatus operates in substantially the same manner as that of FIG. 1 except that it further has the couplers 233 and 235. Hence, the couplers 233 and 235 can be implemented at the same positions in a calibration apparatus of another exemplary embodiment of the present invention.

FIG. 3A illustrates Tx calibration paths in a calibration apparatus according to an exemplary embodiment of the present invention.

Referring to FIG. 3A, the calibration apparatus includes antennas 311, 313 and 315, couplers 319, 321 and 323, TCBs 327, 329 and 331, N Tx modules 333, 337 and 341, Rx modules 335, 339 and 343, a baseband module 345, a combiner/distributor 317, and a switch 325.

For Tx calibration, the baseband module 345 generates Tx calibration reference signals through a reference signal generator and outputs the reference signals to the N Tx modules 333, 337 and 341.

The Tx modules 333, 337 and 341 upconvert the received reference signals to Radio Frequency (RF) signals.

The TCBs 327, 329 and 331 operate in Tx mode. Thus the TCBs 327, 329 and 331 connect their Tx ports to their antenna ports and provide the RF signals to the couplers 319, 321 and 323.

The couplers 319, 321 and 323 couple the received signals to the combiner/distributor 317.

The combiner/distributor 317 combines the signals received from the couplers 319, 321 and 323. Hence, the combiner/distributor 317 functions as a combiner for Tx calibration.

The switch 325 is connected to an Rx port of a first TCB 327 and switches the combined signal to the first TCB 327. If the coupler 235 illustrated in FIG. 2 resides within or without a first Rx module 335, the switch 325 switches its output signal to the first Rx module 335 via the coupler 235.

The first TCB 327 outputs the received signal to the first Rx module 335.

The first Rx module 335 downconverts the received signal to a baseband signal. A calibrator of the baseband module 345 can perform Tx calibration using the baseband signal received from the Rx module 335.

The first Rx module 335 serves as a reference Rx module for the Tx calibration.

For example, one path in which the reference signals are transmitted for the Tx calibration starts from the baseband module 345, passes through the second Tx module 337, the TCB 329, the second coupler 321, the combiner/distributor 317, the switch 325, and the first TCB 327 in this order, and returns to the baseband module 345.

The combiner/distributor 317 combines reference signals received from the first Tx module 333 and the N^{th} Tx module 341 as well as the second Tx module 337. The Tx modules 333, 337 and 341 form calibration paths running through the first Rx module 335 and transmit the reference signals in the calibration paths, for the Tx calibration.

If the combiner/distributor 317 is a switch, the Tx calibration is carried out for all paths sequentially at intervals since a simultaneous Tx calibration for the paths is impossible. Now a description will be made of an exemplary Rx calibration with reference to FIG. 3B.

FIG. 3B illustrates Rx calibration paths in a calibration apparatus according to an exemplary embodiment of the present invention.

Referring to FIG. 3B, the calibration apparatus includes the antennas 311, 313 and 315, the couplers 319, 321 and 323, the TCBs 327, 329 and 331, the Tx modules 333, 337 and 341, the Rx modules 335, 339 and 343, the baseband module 345, the combiner/distributor 317, and the switch 325.

For Rx calibration, the baseband module 345 generates an Rx calibration reference signal through the reference signal generator and outputs the reference signals to the first Tx module 333.

The first Tx module 333 upconverts the reference signal to an RF signal and provides the RF signal to the first TCB 327. If the coupler 233 illustrated in FIG. 2 resides within or without the first Tx module 333, the first Tx module 333 outputs the RF signal to the switch 325 via the coupler 233.

The first TCB 327 has an Rx port connected to an antenna port. Thus, the first TCB 327 outputs the RF signal to the switch 325 via a Tx port. The switch 325, which is connected to the Tx port of the first TCB 327, switches the received signal to the combiner/distributor 317.

The combiner/distributor 317 distributes the reference signal received from the switch 325 to the couplers 319, 321 and 323. The combiner/distributor 317 functions as a distributor for Rx calibration.

The couplers 319, 321 and 323 couple the received signals to the TCBs 327, 329 and 331, respectively.

The TCBs 327, 329 and 331 operate in Rx mode. Thus, the TCBs 327, 329 and 331 connect their antenna ports to their Rx ports and output the coupled signals to the Rx modules 335, 339 and 343, respectively.

The Rx modules 335, 339 and 343 downconvert the received signals to baseband signals. Thus the calibrator of the baseband module 345 can perform Rx calibration using the baseband signals received from the Rx modules 335, 339 and 343.

The first Tx module 333 serves as a reference Tx module, for the Rx calibration.

For example, one path in which the reference signal is transmitted for the Rx calibration starts from the baseband module 345, passes through the first Tx module 333, the first TCB 327, the switch 325, the combiner/distributor 317, the second coupler 321, the second TCB 329, and the first Rx module 339 in this order, and returns to the baseband module 345.

The combiner/distributor 317 distributes the reference signal received from the first Tx module 333 to the Rx modules 335, 339 and 343. The first Tx module 333 forms calibration paths running through the Rx modules 335, 339 and 343 and transmits the reference signal in the calibration paths, for the Rx calibration.

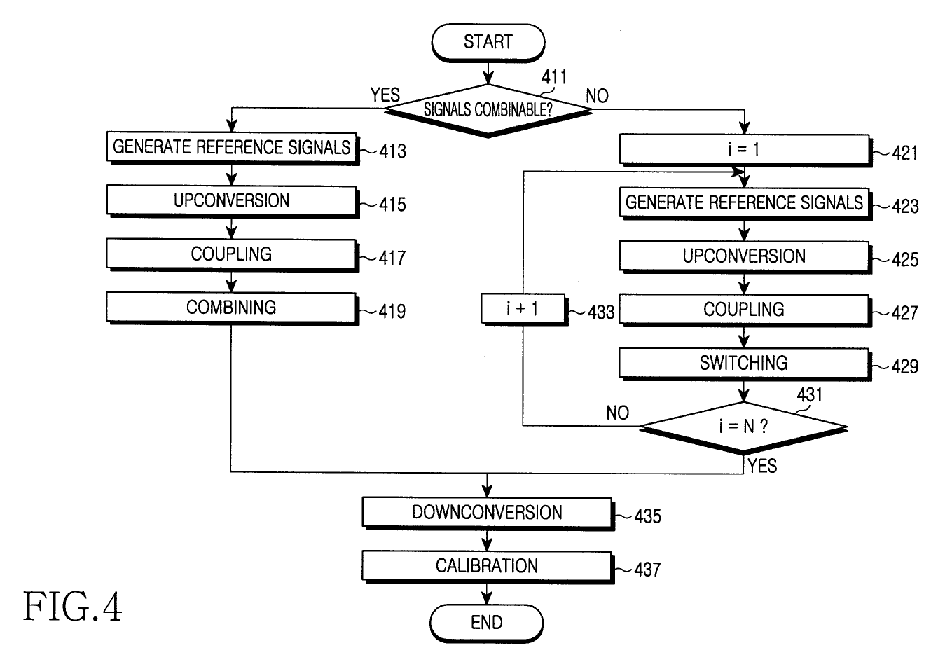

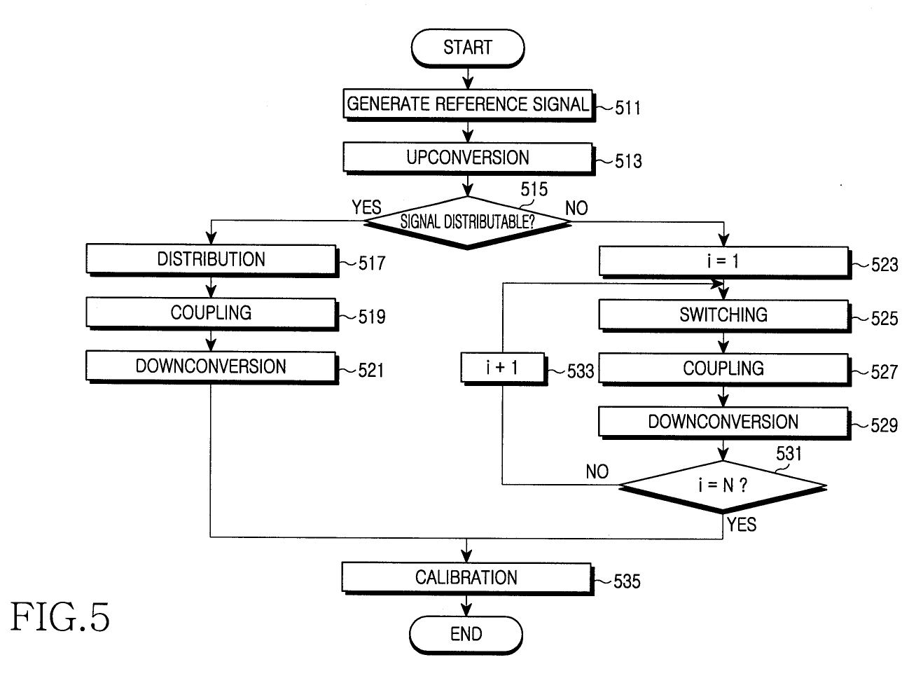

The combiner/distributor 317 can be a switch. In this case, the Rx calibration is carried out for all paths sequentially at intervals since a simultaneous Rx calibration for the paths is impossible. The calibration apparatus has been described above with reference to FIGS. 3A and 3B. Now a description will be made of exemplary methods for performing Tx calibration and Rx calibration in the calibration apparatus illustrated in FIGS. 3A and 3B with reference to FIGS. 4 to 5.

FIG. 4 is a flowchart illustrating a Tx calibration operation according to an exemplary embodiment of the present invention.

Referring to FIG. 4, the calibration apparatus determines whether reference signals for calibration can be combined, that is, whether it includes a combiner/distributor or a switch, in step 411.

If the calibration apparatus includes the combiner/distributor, the calibration apparatus generates a reference signal for calibration in step 413. If a plurality of antennas or Tx/Rx modules are to be calibrated, the calibration apparatus generates a plurality of reference signals for the antennas or Tx/Rx modules.

The calibration apparatus upconverts the reference signal to an RF signal in step 415. In the case of a plurality of reference signals, the calibration apparatus upconverts the individual reference signals to RF signals.

In step 417, the calibration apparatus couples the RF signal. In the case of a plurality of reference signals, the calibration apparatus couples the respective RF signals.

The calibration apparatus combines the reference signals from all paths in step 419 and proceeds to step 435. If signal combination is available, the calibration apparatus upconverts all reference signals simultaneously and combines them.

On the other hand, if the reference signals cannot be combined, for example, if the reference signals are switched in step 411, the calibration apparatus sets a variable i to 1 in order to sequentially switch reference signals from the paths, in step 421. If the calibration apparatus uses a switch, the paths are calibrated sequentially at intervals because all the paths cannot be calibrated at the same time.

The calibration apparatus generates a reference signal in step 423, upconverts the reference signal to an RF signal in step 425, and couples the RF signal in step 427.

The calibration apparatus switches the coupled signal in step 429 and compares i with a threshold N in step 431. N is the number of antennas or Tx modules. Therefore, the calibration apparatus repeats upconversion and coupling in steps 423 through 429 N times for reference signals over the respective paths by switching. If i is different from N, the calibration apparatus goes to step 433 in which the calibration apparatus increases i by 1 in step 433 and goes to step 423.

If i is identical to N, the calibration apparatus goes to step 435.

In step 435, the calibration apparatus downconverts the combined signal obtained in step 419 or the switched signals obtained in step 429 to baseband signals.

In step 437, the calibration apparatus performs calibration using the baseband signals received through each signal transmission path. Specifically, the calibration apparatus acquires Tx calibration vectors from result of comparing the reference signal and the baseband signals. The calibration apparatus applies the Tx calibration vectors to beamforming coefficients for signal transmission. In this manner, the Tx calibration is carried out by compensating Tx signals in Tx paths.

With reference to FIG. 4, Tx calibration in the calibration apparatus has been described. Now a description will be made of Rx calibration in the calibration apparatus with reference to FIG. 5.

FIG. 5 is a flowchart illustrating an Rx calibration operation according to an exemplary embodiment of the present invention.

Referring to FIG. 5, the calibration apparatus generates a reference signal for calibration in step 511 and upconverts the reference signal to an RF signal in step 513. In step 515, the calibration apparatus determines whether the reference signal can be distributed, i.e. whether the calibration apparatus includes a combiner/distributor or a switch.

If the reference signal can be distributed, the calibration apparatus distributes the RF reference signal to paths in step 517 and couples the distributed signals for the respective paths in step 519. In step 521, the calibration apparatus downconverts the coupled signals to baseband signals. Then the calibration apparatus goes to step 535.

On the other hand, if the reference signal cannot be distributed, for example, if the reference signal can be switched as a plurality of reference signals in step 511, the calibration apparatus sets a variable i to 1 to switch the reference signal to the respective paths in step 523. In the case where the calibration apparatus uses a switch, calibration is carried out sequentially for all Rx paths at intervals because a simultaneous calibration for the Rx paths is impossible.

In step 525, the calibration apparatus switches the RF reference signal to each path. The calibration apparatus couples the switched reference signals in step 527 and downconverts the coupled signals to baseband signals in step 529.

In step 531, the calibration apparatus compares i with a threshold N. N is the number of antennas or Rx modules. Therefore, the calibration apparatus iteratively performs steps 525 to 531 to switch the reference signal N times, couple the N reference signals, and downconvert the coupled N reference signals. If i is different from N, the calibration apparatus increases i by 1 in step 533 and returns to step 525. If i is equal to N, the calibration apparatus proceeds to step 535.

In step 535 the calibration apparatus performs calibration using the baseband signals received through each signal reception path. Specifically, the calibration apparatus acquires Rx calibration vectors from result of comparing the reference signal and the baseband signals. The calibration apparatus applies the calibration vectors to beamforming coefficients, for signal reception. In this manner, the Rx calibration is carried out by compensating signals received in Rx paths.

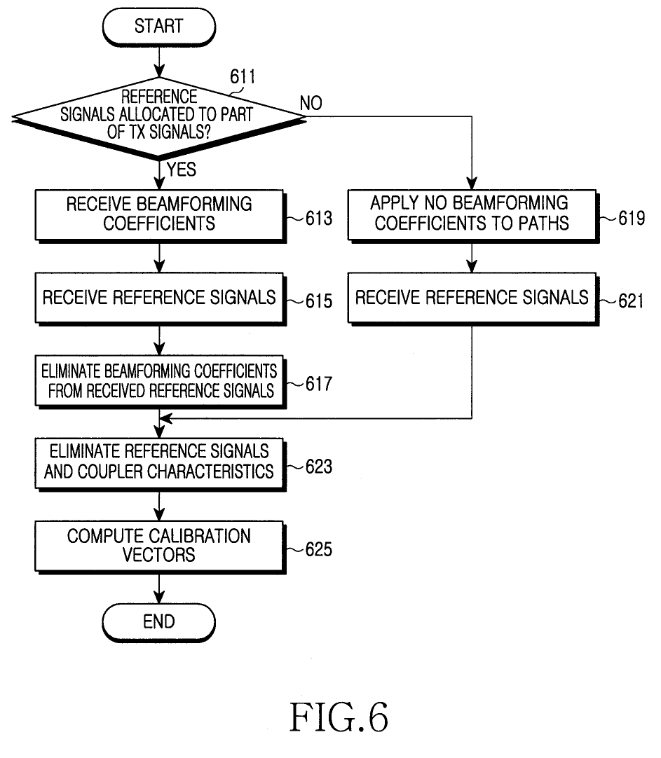

The calibration will be described with reference to FIG. 6.

FIG. 6 is a flowchart illustrating a calibration operation according to an exemplary embodiment of the present invention. The calibration operation is applicable to both the Tx calibration depicted in FIG. 4 and the Rx calibration depicted in FIG. 5.

Referring to FIG. 6, calibration takes place in the calibration apparatus, particularly in the calibrator of the baseband module in the calibration apparatus. The calibrator performs calibration as follows.

The calibrator determines whether a reference signal has been allocated to occupy part of each Tx signal in step 611. If the reference signal has been allocated to part of each Tx signal, the calibrator goes to step 613. If the reference signal has not been allocated to occupy part of each Tx signal, for example, if the reference signal has been allocated to occupy an entire Tx frame, the calibrator goes to step 619. The reference signal is denoted by C(t).

In step 613, the calibrator receives beamforming coefficients W_{b1}, W_{b2}, . . . , W_{bN}. The calibrator receives the reference signal from each calibration path illustrated in FIGS. 3A and 3B in step 615. The received reference signal is the product of the reference signal, a beamforming coefficient for the path, and variations in the amplitude and phase of the reference signal over the path. In Tx calibration, for example, the first Rx module R1 forms a common feedback path in which the downconverted reference signal of each path is provided to the calibrator. Let the amplitude and phase variation caused by the common feedback path be denoted by R1=α_{feedback}e^{jθ}^{_{feedback}}. Then the signals received at the calibrator are given as

$$\begin{matrix}{C}_{1} ( t ) = T 1 R 1 = {W}_{b 1} \cdot {α}_{1} C ( t ) {e}^{j {θ}_{1 , cal}} {α}_{feedback} {e}^{j {θ}_{feedback}} \\ {C}_{2} ( t ) = T 2 R 2 = {W}_{b 2} \cdot {α}_{2} C ( t ) {e}^{j {θ}_{2 , cal}} {α}_{feedback} {e}^{j {θ}_{feedback}} \\ ⋮ \\ {C}_{N} ( t ) = TN R 1 = {W}_{b N} \cdot {α}_{N} C ( t ) {e}^{j {θ}_{N , cal}} {α}_{feedback} {e}^{j {θ}_{feedback}}\end{matrix} \qquad ( 3 )$$

where α_{N} denotes an amplitude variation from an N^{th} path or a signal attenuation in the N^{th} path and e^{jθ}^{_{N, cal}} denotes a phase variation from the N^{th} path.

In step 617, the calibrator eliminates the beamforming coefficient W_{bN} applied to each path from the received signal C_{N}(t) from the path. Then the calibrator proceeds to step 623.

Meanwhile, the calibrator does not apply a beamforming coefficient to each Tx/Rx path during a reference signal generation time (or frame) in step 619. The calibrator receives the reference signal from each calibration path in step 621 and goes to step 623. The received reference signal is identical to the beamforming coefficient-free reference signal achieved in step 617.

In step 623, the calibrator eliminates the reference signal C(t) and coupler characteristics R_{coupler}, i.e. computes

$$\frac{{C}_{N} ( t ) / {R}_{coupler N}}{C ( t )} .$$

### In step 625, the calibrator computes calibration vectors.

For Tx calibration, the calibrator computes calibration vectors by

$$\begin{matrix}{w}_{c , 1} = conj [ \frac{{C}_{1} ( t ) / ( {W}_{b 1} \cdot {R}_{coupler 1} )}{C ( t )} ] \\ {w}_{c , 2} = conj [ \frac{{C}_{2} ( t ) / ( {W}_{b 2} \cdot {R}_{coupler 2} )}{C ( t )} ] \\ ⋮ \\ {w}_{c , N} = conj [ \frac{{C}_{N} ( t ) / ( {W}_{b N} \cdot {R}_{coupler N} )}{C ( t )} ]\end{matrix} \qquad ( 4 )$$

For Rx calibration, the received reference signals involve T1=α_{feedback}e^{jθ}^{_{feedback}}. Thus, the above equation is computed using C₁(t)=T1R1, C₂(t)=T1R2, . . . , C_{N}(t)=T1RN. T represents a Tx module and R represents an Rx module.

Tx and Rx paths are compensated by applying the computed Tx calibration vectors for signal transmission and the computed Rx calibration for signal reception.

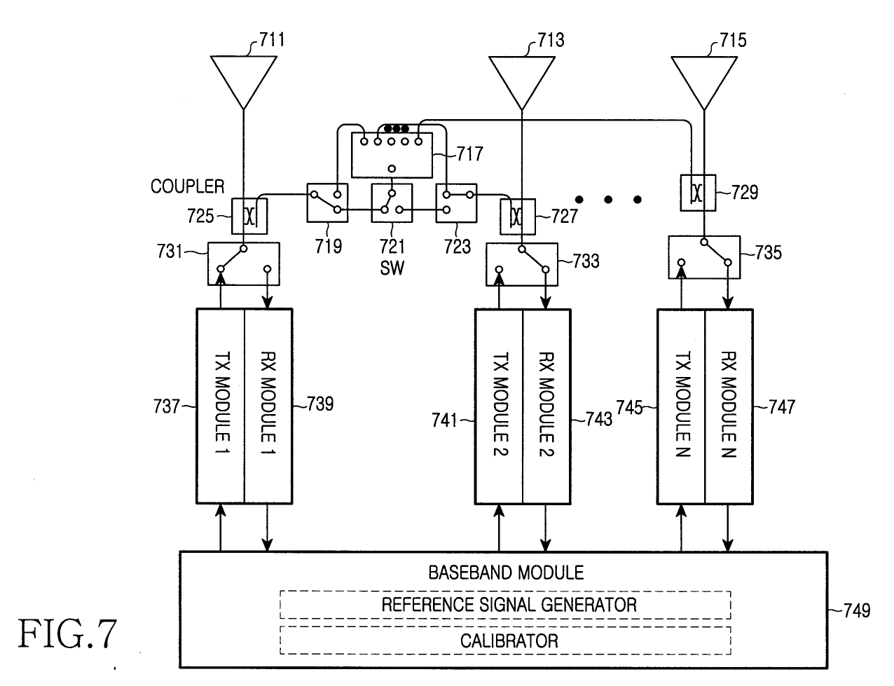

FIG. 7 illustrates a calibration apparatus according to another exemplary embodiment of the present invention.

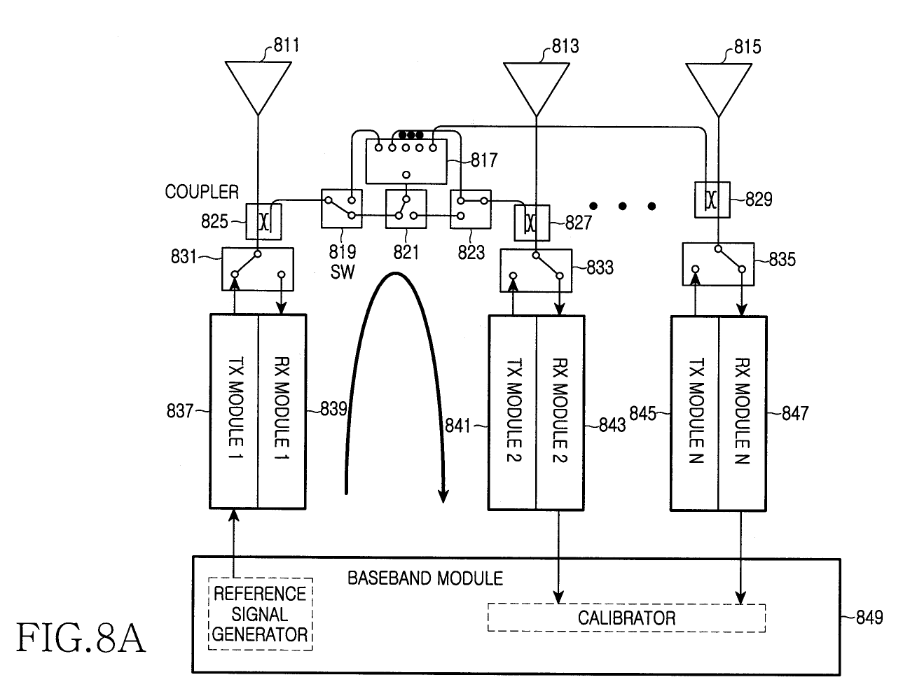

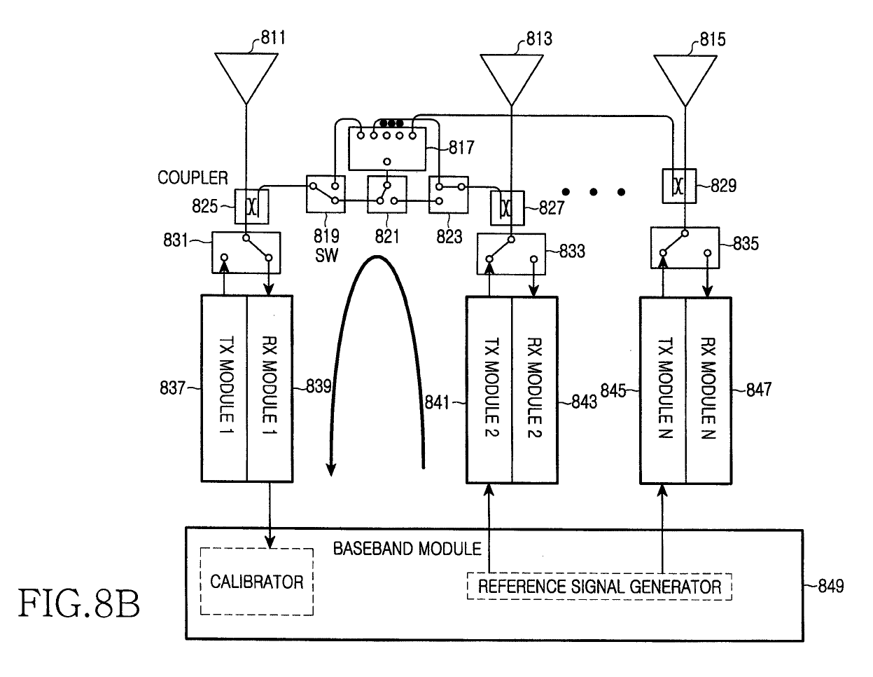

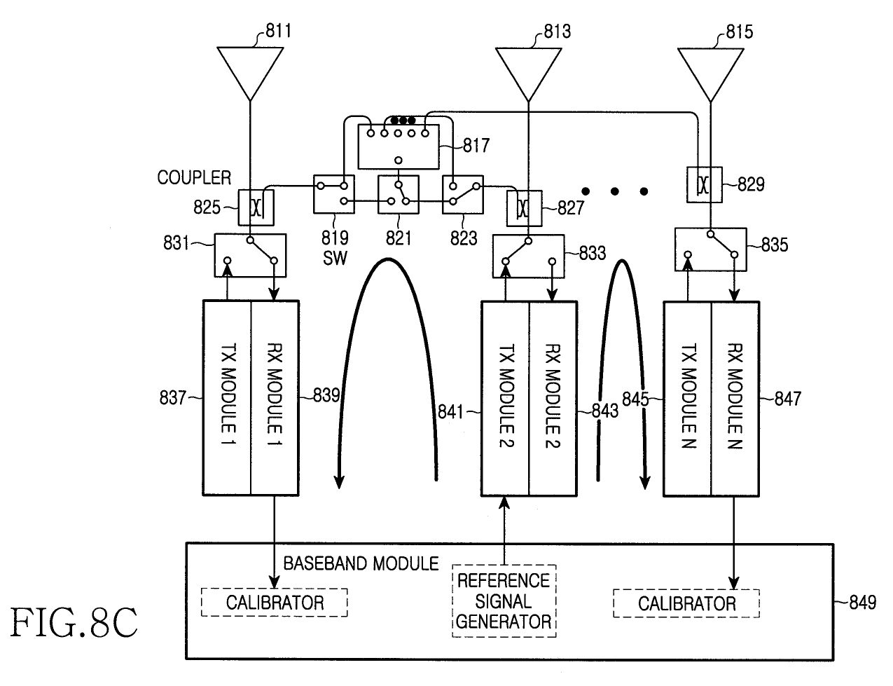

Compared to the calibration apparatus described in FIGS. 1 to 6 in which Tx calibration and Rx calibration are performed separately during signal transmission and reception, the calibration apparatus illustrated in FIG. 7 can simultaneously compute Tx calibration vectors and Rx calibration vectors by the operations illustrated in FIGS. 8A, 8B and 8C during a Tx and Rx calibration time period (e.g. frame).

Referring to FIG. 7, the calibration apparatus includes antennas 711, 713 and 715, couplers 725, 727 and 729, TCBs 731, 733 and 735, Tx modules 737, 741 and 745, Rx modules 739, 743 and 747, a baseband module 749, a combiner/distributor 717, and switches 719, 721 and 723.

The baseband module 749 includes a reference signal generator for generating a reference signal and a calibrator for performing calibration using a signal received from each path. The calibrator receives the reference signal from each path and extracts a calibration vector for the path. It also compensates Tx/Rx hardware paths by applying the calibration vectors to beamforming coefficients used for beamforming. The calibrator may perform calibration continuously during signal transmission/reception, or every interval if hardware performance does not change fast.

The Tx modules 737, 741 and 745 upconvert signals received from the baseband module 145 and provide the upconverted signals to the TCBs 731, 733 and 735. The Rx modules 739, 743 and 747 downconvert signals received from the TCBs 731, 733 and 735 and provide the downconverted signals to the baseband module 749.

The TCBs 731, 733 and 735 output the signals received from the Tx modules 737, 741 and 745 to the couplers 725, 727 and 729, respectively, and output signals received through the antennas 711, 713 and 715 to the Rx modules 739, 743 and 747. The TCBs 731, 733 and 735 include Tx ports connected to the Tx modules 737, 741 and 745, Rx ports connected to the Rx modules 739, 743 and 747, and antenna ports connected to the antennas 711, 713 and 715.

The couplers 725, 727 and 729 couple reference signals input to the antennas 711, 713 and 715 to the combiner/distributor 717, or receive reference signals from the combiner/distributor 717, for calibration.

The antennas 711, 713 and 715 transmit or receive signals.

Compared to the calibration apparatus illustrated in FIG. 1 in which a signal transmitted through the first Tx module travels to the first Rx module, the calibration apparatus illustrated in FIG. 7 performs calibration by further using three additional switches.

The combiner/distributor 717 is connected to the switches 719, 721 and 723. The first switch 719 is connected to the first coupler 725 and the third switch 723 is connected to the second coupler 727. The second switch 721 is connected between the first and third switches 719 and 723.

To be more specific about the connection relationship of the switches 719, 721 and 723, the first switch 719 is connected to the first coupler 725, the combiner/distributor 717, and the second switch 721. The second switch 721 is connected to the first switch 719, the combiner/distributor 717, and the third switch 723. The third switch 723 is connected to the second switch 721, the combiner/distributor 717, and the second coupler 727.

The combiner/distributor 717 can be a switch. In this case, signal processing occurs sequentially over respective paths, which will not be described in more detail.

Calibration in the above-described calibration apparatus will be described below with reference to FIGS. 8A, 8B and 8C.

FIGS. 8A, 8B and 8C illustrate calibration paths in a calibration apparatus according to an exemplary embodiment of the present invention.

Before describing FIGS. 8A, 8B and 8C, it is made clear that the calibration apparatus forms three calibration paths and performs calibration using reference signals received from the calibration paths. This calibration apparatus is shown for the purpose of describing operations of the calibration apparatus illustrated in FIG. 7.

Referring to FIG. 8A, the calibration apparatus includes antennas 811, 813 and 815, couplers 825, 827 and 829, TCBs 831, 833 and 835, Tx modules 837, 841 and 845, Rx modules 839, 843 and 847, a baseband module 849, a combiner/distributor 817, and switches 819, 821 and 823.

For calibration, the baseband module 849 generates a reference signal for calibration through a reference signal generator and outputs the reference signal to the first Tx module 837.

The Tx module 837 upconverts the reference signal to an RF signal. The first TCB 831 operates in Tx mode and thus outputs the RF signal received from the Tx module 837 to the first coupler 825 connected to the first antenna 811.

The first coupler 825 couples the received signal to the first switch 819. The first switch 819 switches the received signal to the second switch 821. The second switch 821 switches the received signal to the combiner/distributor 817.

The combiner/distributor 817 distributes the received signal to the first switch 819, the third switch 823, and the N^{th} coupler 829. Since the first switch 819 is not connected to the first coupler 825, it does not switch the received signal to the first coupler 825. The third switch 827 switches the received signal to the second coupler 827.

The second coupler 827 and the N^{th} coupler 829 couple the distributed signals to the second TCB 833 and the N^{th} TCB 835, respectively.

Both the second TCB 833 and the N^{th} TCB 835 operate in Rx mode and thus provide the received signals to the second Rx module 843 and the N^{th} Rx module 847, respectively.

The second Rx module 843 and the N^{th} Rx module 847 downconvert the received signals to baseband signals and provide the baseband signals to a calibrator of the baseband module 849.

Thus, the baseband module 849 acquires calibration signals through the calibrator.

Establishment of a first calibration path and acquisition of calibration signals have been described above. For forming the first calibration path, the first TCB 831 operates in the Tx mode and the other TCBs 833 and 835 operate in the Rx mode. The first switch 819 switches the first coupler 825 to the second switch 821 and the second switch 821 switches the first switch 819 to the combiner/distributor 817. The third switch 823 switches the combiner/distributor 817 to the second coupler 827. The combiner/distributor 817 functions as a distributor for distributing an input signal as a plurality of signals.

An exemplary method of forming a second calibration path and acquiring a calibration signal from the second calibration path will be described below with reference to FIG. 8B.

Referring to FIG. 8B, the calibration apparatus includes the antennas 811, 813 and 815, the couplers 825, 827 and 829, the TCBs 831, 833 and 835, the Tx modules 837, 841 and 845, the Rx modules 839, 843 and 847, the baseband module 849, the combiner/distributor 817, and the switches 819, 821 and 823.

For calibration, the baseband module 849 generates a reference signal through the reference signal generator and outputs the reference signal to the second and N^{th} Tx modules 841 and 845.

The Tx modules 841 and 845 upconvert the reference signal to RF signals. The second and N^{th} TCBs 833 and 835 operate in the Tx mode. Thus the TCBs 833 and 835 control the RF signals received from the Tx modules 841 and 845 to be output to the second coupler 827 connected to the second antenna 813 and the N^{th} coupler 829 connected to the N^{th} antenna 815.

The second coupler 827 couples the received signal to the third switch 823 and the N^{th} coupler 829 couples the received signal to the combiner/distributor 817.

The third switch 823 switches the received signal to the combiner/distributor 817. The combiner/distributor 817 combines the received signals and outputs the combined signal to the second switch 821. The second switch 821 switches the received signal to the first switch 819.

The first switch 819 switches the received signal to the first coupler 825 and the first coupler 825 couples the received signal to the first TCB 831.

The first TCB 831 operates in the Rx mode and outputs the received signal to the first Rx module 839.

The first Rx module 839 downconverts the received signal to a baseband signal and provides the baseband signal to the calibrator of the baseband module 849.

Thus, the baseband module 849 acquires a calibration signal through the calibrator.

Acquisition of a calibration signal through the second calibration path has been described above. To establish the second calibration path, the first TCB 831 operates in the Rx mode and the other TCBs 833 and 835 operate in the Tx mode. The third switch 823 switches the second coupler 827 to the combiner/distributor 817 and the second switch 821 switches the combiner/distributor 817 to the first switch 819. The first switch 819 switches the second switch 821 to the first coupler 825. The combiner/distributor 817 functions as a combiner for combining a plurality of input signals.

An exemplary method of forming a third calibration path and acquiring calibration signals will be described below with reference to FIG. 8C.

Referring to FIG. 8C, the calibration apparatus includes the antennas 811, 813 and 815, the couplers 825, 827 and 829, the TCBs 831, 833 and 835, the Tx modules 837, 841 and 845, the Rx modules 839, 843 and 847, the baseband module 849, the combiner/distributor 817, and the switches 819, 821 and 823.

For calibration, the baseband module 849 generates a reference signal through the reference signal generator and outputs the reference signal to the second Tx module 841.

The second Tx module 841 upconverts the reference signal to an RF signal. The second TCB 833 operates in the Tx mode and thus outputs the RF signal to the second coupler 827 connected to the second antenna 813.

The second coupler 827 couples the received signal to the third switch 823. The third switch 823 switches the received signal to the second switch 821 and the second switch 821 switches the received signal to the combiner/distributor 817.

The combiner/distributor 817 distributes the received signal to the first switch 819, the third switch 823, and the N^{th} coupler 829. The first switch 819 switches the received signal to the first coupler 825, while the third switch 823 cannot switch the received signal to the second coupler 827.

The first and N^{th} couplers 825 and 829 couple the distributed signals to the first and N^{th} TCBs 831 and 835, respectively.

Both the first and N^{th} TCBs 831 and 835 operate in the Rx mode and output the received signals to the first and N^{th} Rx modules 839 and 847.

The first and N^{th} Rx modules 839 and 847 downconvert the received signals to baseband signals and provide the baseband signals to the calibrator of the baseband module 849.

Thus, the baseband module 849 acquires the calibration signals through the calibrator.

Acquisition of calibration signals through the third calibration path has been described above. To establish the third calibration path, the second TCB 833 operates in the Tx mode and the other TCBs 831 and 835 operate in the Rx mode. The third switch 823 switches the second coupler 827 to the second switch 821 and the second switch 821 switches the third switch 823 to the combiner/distributor 817. The first switch 819 switches the combiner/distributor 817 to the first coupler 825. The combiner/distributor 817 functions as a distributor for distributing an input signal as a plurality of signals.

As with the calibration apparatus illustrated in FIGS. 3A and 3B, the combiner/distributor can be configured as a switch in the calibration apparatus illustrated in FIGS. 8A, 8B and 8C. This calibration apparatus forms the calibration paths by controlling the TCBs 831, 833 and 835, the combiner/distributor 817, and the switches 819, 821 and 823.

In an exemplary embodiment in which the communication system is a time-division one, the other Tx and Rx modules except the first Tx and Rx modules 837 and 839 and the second Tx and Rx modules 841 and 843 operate in the Rx mode in the first calibration path, in the Tx mode in the second calibration path, and in the Rx mode in the third calibration path. The first TCB 831 operates in the Tx mode in the first calibration path, in the Rx mode in the second calibration path, and in the Rx mode in the third calibration path. The second TCB 833 operates in the Rx mode in the first calibration path, in the Tx mode in the second calibration path, and in the Tx mode in the third calibration path.

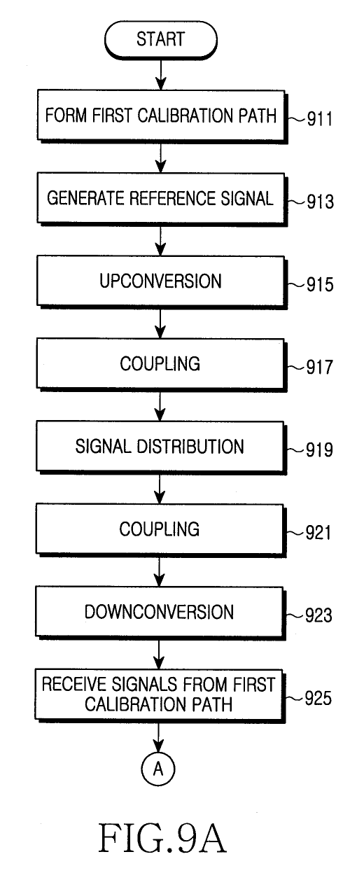

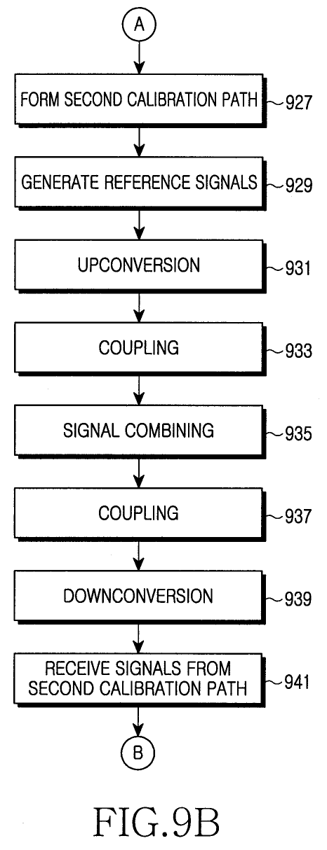

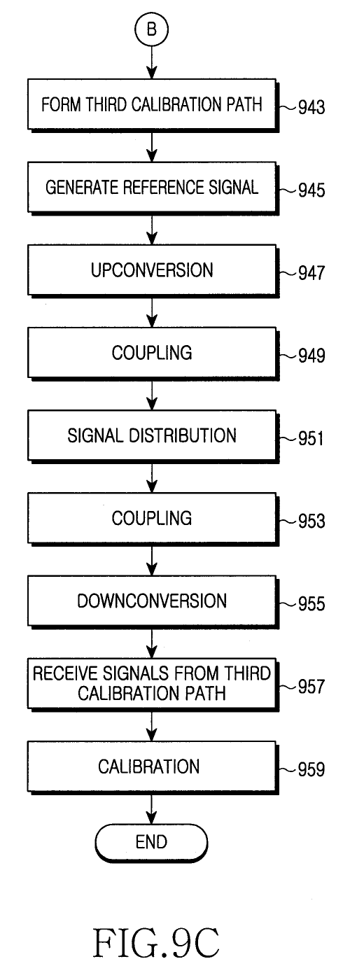

With reference to FIGS. 9A, 9B and 9C, exemplary reference signal processing methods in the calibration apparatus illustrated in FIGS. 8A, 8B and 8C will be described below.

FIGS. 9A, 9B and 9C are flowcharts illustrating reference signal processing in the course of the calibration paths according to an exemplary embodiment of the present invention.

Referring to FIG. 9A, the calibration apparatus forms the first calibration path illustrated in FIG. 8A in step 911 and generates a reference signal in step 913. The calibration apparatus upconverts the reference signal to an RF signal in a single reference Tx path in step 915 and couples the RF signal in step 917.

The calibration apparatus distributes the coupled signal in step 919, couples the distributed signals in step 921, and downconverts the coupled signals to baseband signals in step 923.

In step 925, the calibration apparatus acquires the baseband signals as calibration signals for the first calibration path and goes to step 927.

Referring to FIG. 9B, the calibration apparatus forms the second calibration path in step 927 and generates reference signals in step 929. The calibration apparatus upconverts the reference signals to RF signals for respective paths in step 931 and couples the RF signals in step 933.

The calibration apparatus combines the coupled signals in step 935, couples the combined signal in step 937, and downconverts the coupled signal to a baseband signal in step 939.

In step 941, the calibration apparatus acquires the baseband signal as a calibration signal for the second calibration path and goes to step 943.

Referring to FIG. 9C, the calibration apparatus forms the third calibration path in step 943 and generates a reference signal in step 945. The calibration apparatus upconverts the reference signal to an RF signal in step 947 and couples the RF signal in step 949. The calibration apparatus upconverts the reference signal to RF signal through different calibration path of the step 915.

The calibration apparatus distributes the coupled signal in step 951, couples the distributed signals in step 953, and downconverts the coupled signals to baseband signals in step 955.

In step 957, the calibration apparatus acquires the baseband signals as calibration signals for the third calibration path and goes to step 959.

The calibration apparatus performs calibration using the calibration signals received from the first, second and third paths in step 959.

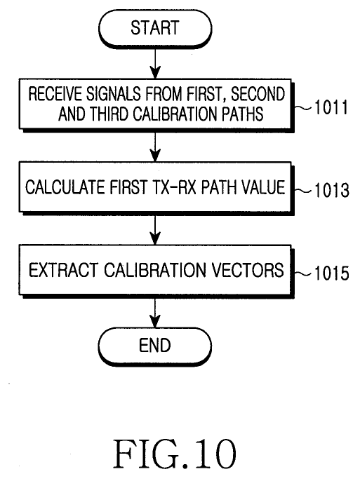

An exemplary calibration process in the calibration apparatus, especially in the calibrator, will be described with reference to FIG. 10.

FIG. 10 is a flowchart illustrating a calibration operation according to an exemplary embodiment of the present invention.

Referring to FIG. 10, the calibrator receives calibration signals from the first, second and third calibration paths in step 1011. Compared to the calibration apparatus illustrated in FIG. 1, a self-feedback path is not established in an Rx module being the counterpart of a Tx module that transmits a reference signal in the first and second calibration paths. That is, a reference signal transmitted from the Tx module is not provided to the Rx module connected to the same antenna together with the Tx module. That is why the third calibration path is further established. The received signals from the first, second and third calibration paths are given as

$$\begin{matrix}A 1 = [ T 1 R 2 , T 1 R 3 , … , T 1 RN , ] \\ = C ( t ) \cdot {α}_{1} {e}^{j {θ}_{T 1}} {β}_{2} {e}^{j {θ}_{R 2}} , C ( t ) \cdot {α}_{1} {e}^{j {θ}_{T 1}} {β}_{3} {e}^{j {θ}_{R 3}} , … , \\ C ( t ) \cdot {α}_{1} {e}^{j {θ}_{T 1}} {β}_{N} {e}^{j {θ}_{RN}} \\ A 2 = [ T 2 R 1 , T 3 R 1 , … , TNR 1 , ] \\ = C ( t ) \cdot {α}_{2} {e}^{j {θ}_{T 2}} {β}_{2} {e}^{j {θ}_{R 1}} , C ( t ) \cdot {α}_{3} {e}^{j {θ}_{T 3}} {β}_{2} {e}^{j {θ}_{R 1}} , … , \\ C ( t ) \cdot {α}_{N} {e}^{j {θ}_{TN}} {β}_{2} {e}^{j {θ}_{R 1}} \\ A 3 = [ T 2 R 1 , T 2 R 3 , … , T 2 RN , ] \\ = C ( t ) \cdot {α}_{2} {e}^{j {θ}_{T 2}} {β}_{1} {e}^{j {θ}_{R 1}} , C ( t ) \cdot {α}_{2} {e}^{j {θ}_{T 2}} {β}_{3} {e}^{j {θ}_{R 3}} , … , \\ C ( t ) \cdot {α}_{2} {e}^{j {θ}_{T 2}} {β}_{N} {e}^{j {θ}_{RN}}\end{matrix} \qquad ( 5 )$$

where A1 denotes signals received from the first calibration path, A2 denotes signals received from the second calibration path, A3 denotes signals received from the third calibration path, T1 to TN denote the first to N^{th} Tx modules, R1 to RN denote the first to N^{th} Rx modules, α_{N} and β_{N} denote amplitude variations from the N^{th} Tx and Rx paths, respectively, and e^{jθ}^{_{TN}} and e^{jθRN} denote phase variations from the N^{th} Tx and Rx paths, respectively.

Thus, Equation (5) describes reference signals that have traveled in paths running through the Tx and Rx modules. For instance, T1R2 is a reference signal that has started from the baseband module and traveled through the first Tx module, the first TCB, the first coupler, the first switch, the second switch, the combiner/distributor, the third switch, the second coupler, the second TCB, and the second receiver, sequentially in this order.

In step 1013, the calibrator acquires a value for a reference Tx-Rx path, for example, a first Tx-Rx path running through the first Tx and Rx modules by

Path 2 Factor=A1(2)/A3(2)=T1R3/T2R3=T1/T2

A2(1)·Path 2 Factor=T2R1·T1/T2=T1R1 (6)

where numerals in the brackets following A1, A2 and A3 denote terms representing A1, A2 and A3, respectively in Equation (5). For example, A1(2) denotes the second term of A1 in Equation (5). Path 2 Factor denotes a factor by which the reference Tx-Rx path value, i.e. the first Tx-Rx path value is calculated.

In step 1015, the calibrator extracts a calibration vector for each path using T1R1 expressed as

T1R1=C(t)·α₁e^{jθ}^{_{T1}}β₁e^{jθ}^{_{R1}} (7)

A calibration vector for the Rx module over each path is computed by

$$\begin{matrix}A 1 / T 1 R 1 = [ T 1 R 2 / T 1 R 1 , T 1 R 3 / T 1 R 1 , … , T 1 RN / T 1 R 1 ] \\ = [ R 2 / R 1 , R 3 / R 1 , … , RN / R 1 ] \\ = [ \begin{matrix}{β}_{2} {e}^{j {θ}_{R 2}} / {β}_{1} {e}^{j {θ}_{R 1}} , {β}_{3} {e}^{j {θ}_{R 3}} / {β}_{1} {e}^{j {θ}_{R 1}} , … , \\ {β}_{N} {e}^{j {θ}_{RN}} / {β}_{1} {e}^{j {θ}_{R 1}}\end{matrix} ]\end{matrix} \qquad ( 8 )$$

A calibration vector for the Tx module over each path is computed by

$$\begin{matrix}A 2 / T 1 R 1 = [ T 2 R 1 / T 1 R 1 , T 3 R 1 / T 1 R 1 , … , TN R 1 / T 1 R 1 ] \\ = [ T 2 / T 1 , T 3 / T 1 , … , TN / T 1 ] \\ = [ \begin{matrix}{α}_{2} {e}^{j {θ}_{T 2}} / {α}_{1} {e}^{j {θ}_{T 1}} , {α}_{3} {e}^{j {θ}_{T 3}} / {α}_{1} {e}^{j {θ}_{T 1}} , … , \\ {α}_{N} {e}^{j {θ}_{TN}} / {α}_{1} {e}^{j {θ}_{T 1}}\end{matrix} ]\end{matrix} \qquad ( 9 )$$

Since R2/R1,R3/R1, . . . ,RN/R1 and T2/T1,T3/T1, . . . ,TN/T1 can be calculated, the amplitude and phase variations in each Tx path and each Rx path relative to the first Tx module 737 and the first Rx module 739 can be computed. Subsequently, final Tx and Rx calibration vectors can be achieved by eliminating coupler characteristics R_{coupler} from A1/T1R1 and A2/T1R1 as follows.

$${w}_{T} = conj [ \frac{{A}_{1} / {R}_{coupler}}{T 1 R 1} ] \\ {w}_{R} = conj [ \frac{{A}_{2} / {R}_{coupler}}{T 1 R 1} ] \qquad ( 10 )$$

where w_{T} denotes a Tx calibration vector and w_{R} denotes an Rx calibration vector.

Thus, Tx and Rx hardware paths can be compensated, i.e. calibration can be performed by applying the calibration vectors to beamforming coefficients during signal transmission and reception.

As is apparent from the above description, exemplary embodiments of the present invention advantageously enable calibration without using additional Tx and Rx hardware devices. As a result, system complexity is minimized and hardware configuration cost is saved.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A calibration method in a communication system, the method comprising:
generating baseband reference signals for signal transmission paths and upconverting the baseband reference signals to Radio Frequency (RF) signals;
coupling the RF signals;
combining the coupled signals;
downconverting the combined signal to a baseband signal; and
acquiring transmission calibration vectors using the baseband signal.

2. The calibration method of claim 1, wherein the communication system comprises a time-division scheme.

3. The calibration method of claim 1, further comprising performing transmission calibration by applying the transmission calibration vectors to beamforming coefficients for transmission signals.

4. The calibration method of claim 1, wherein the combining of the coupled signals comprises:
switching the coupled signals sequentially one by one;
downconverting the switched signals to baseband signals; and
acquiring transmission calibration vectors using the baseband signals.

5. A calibration method in a communication system, the method comprising:
generating a reference signal;
upconverting the reference signal to a Radio Frequency (RF) signal;
distributing the RF signal to signal reception paths;
coupling the distributed signals;
downconverting the coupled signals to baseband signals; and
acquiring reception calibration vectors using the baseband signals.

6. The calibration method of claim 5, wherein the communication system comprises a time-division scheme.

7. The calibration method of claim 5, further comprising performing reception calibration by applying the reception calibration vectors to beamforming coefficients for received signals.

8. The calibration method of claim 5, wherein the distributing of the RF signals comprises:
switching the coupled signals sequentially one by one;
downconverting the switched signals to baseband signals; and
acquiring reception calibration vectors using the baseband signals.

9. A calibration method in a communication system, the method comprising:
forming first, second and third calibration paths;
acquiring first, second and third calibration signals for use in calibration by transmitting reference signals in the first, second and third calibration paths; and
acquiring calibration vectors using the first, second and third calibration signals.

10. The calibration method of claim 9, wherein the communication system comprises a time-division scheme.

11. The calibration method of claim 9, wherein the acquiring of the first calibration signal comprises:
generating a first reference signal for a first reference transmission and reception path;
upconverting the first reference signal to a Radio Frequency (RF) signal;
coupling the RF signal;
distributing the coupled signal to reception paths except for a reception path of the first reference transmission-reception path;
downconverting the distributed signals to baseband signals; and
acquiring the first calibration signal using the baseband signals.

12. The calibration method of claim 11, wherein the acquiring of the second calibration signal comprises:
generating second reference signals for transmission paths except for a transmission path of the first reference transmission and reception path;
upconverting the second reference signals to RF signals;
coupling the RF signals;
combining the coupled signals;
downconverting the combined signal to a baseband signal; and
acquiring the second calibration signal using the baseband signal.

13. The calibration method of claim 12, wherein the acquiring of the third calibration signal comprises:
generating a third reference signal for a second reference transmission and reception path;
upconverting the third reference signal to an RF signal;
coupling the RF signal;
distributing the coupled signal to reception paths except for a reception path of the second reference transmission-reception path;
downconverting the distributed signals to baseband signals; and
acquiring the third calibration signal using the baseband signals.

14. The calibration method of claim 13, wherein the first reference transmission and reception path comprises a path different from the second reference transmission and reception path.

15. The calibration method of claim 9, wherein the calibration comprises:
calculating a factor using the first and third calibration signals, for calculating a value of the first reference transmission and reception path;
calculating the value of the first reference transmission and reception path by multiplying the factor by the second calibration signal;
acquiring transmission calibration vectors by dividing the first calibration signal by the value of the first reference transmission and reception path; and
acquiring reception calibration vectors by dividing the second calibration signal by the value of the first reference transmission and reception path.

16. The calibration method of claim 15, wherein the acquiring of the transmission calibration vectors comprises eliminating coupler characteristics and further wherein the acquiring of the reception calibration vectors comprises eliminating coupler characteristics.

17. The calibration method of claim 16, further comprising performing transmission calibration by applying the transmission calibration vectors to beamforming coefficients for transmission signals.

18. The calibration method of claim 16, further comprising performing reception calibration by applying the reception calibration vectors to beamforming coefficients for received signals.

19. A calibration apparatus in a communication system, comprising:
a baseband module for generating reference signals for transmission/reception paths and acquiring calibration vectors using the reference signals received after transmitting the reference signals in the transmission/reception paths;
a Radio Frequency (RF) module for radio-processing the reference signals and providing the processed reference signals to the baseband module; and
a calibration path controller for controlling transmission and reception paths of the reference signals.

20. The calibration apparatus of claim 19, wherein the baseband module comprises:
a reference signal generator for generating the reference signals for the transmission/reception paths; and
a calibrator for acquiring transmission calibration vectors using the received reference signals.

21. The calibration apparatus of claim 20, wherein the calibrator performs transmission/reception calibration by applying the transmission calibration vectors to beamforming coefficients for transmission signals and applying the reception calibration vectors to beamforming coefficient for transmission signals.

22. The calibration apparatus of claim 20, wherein the RF module comprises:
a transmission module for upconverting a reference signal to an RF signal;
a reception module for downconverting an RF signal to a baseband signal;
an antenna for performing at least one of transmitting the RF signal received from the transmission module and outputting a received signal to the reception module; and
a coupler connected to the antenna, for coupling a signal.

23. The calibration apparatus of claim 22, wherein the RF module comprises at least one antenna, as many transmission modules as the at least one antenna, and as many reception modules as the at least one antenna.

24. The calibration apparatus of claim 22, wherein the calibration path controller comprises:
a transmission control block connected to the transmission module and the reception module of the RF module, for operating in at least one of transmission mode and reception mode;
a combiner and distributor connected to the coupler and a switch, for performing at least one of combining and distributing signals; and
the switch connected to transmission and reception ports of the transmission control block, for switching between the transmission control block and the combiner and distributor.

25. The calibration apparatus of claim 24, wherein the combiner and distributor comprises a switch.

26. The calibration apparatus of claim 22, wherein the calibration path controller comprises:
a transmission control block connected to the transmission module and the reception module of the RF module, for operating in one of transmission mode and reception mode;
a first switch connected to a first coupler and a second switch;
the second switch connected to the first switch and a third switch;
the third switch connected to the second switch and a second coupler; and
a combiner and distributor connected to the first, second and third switches and a plurality of couplers.

27. The calibration apparatus of claim 26, wherein the plurality of couplers connected to the combiner and distributor do not include the first and second couplers.

28. A calibration apparatus in a communication system, comprising:
a reference signal generator for generating reference signals for signal transmission paths;
a plurality of transmission modules for upconverting the reference signals to Radio Frequency (RF) signals for the signal transmission paths;
a plurality of couplers for coupling the RF signals;
a combiner and distributor for combining the coupled signals;
a first reception module for downconverting the combined signal to a baseband signal; and
a calibrator for acquiring transmission calibration vectors using the baseband signal.

29. The calibration apparatus of claim 28, wherein the communication system comprises a time-division scheme.

30. The calibration apparatus of claim 28, wherein the calibrator performs transmission calibration by applying the transmission calibration vectors to beamforming coefficients for transmission signals.

31. The calibration apparatus of claim 28, further comprising a plurality of transmission control blocks for transmitting signals received from the transmission modules in transmission mode.

32. The calibration apparatus of claim 31, further comprising a switch for switching a signal received from a reception port of a first transmission control block connected to a first reception module to the combiner and distributor.

33. The calibration apparatus of claim 32, further comprising a switch for sequentially switching signals received from the plurality of transmission control blocks to the reception port of the first transmission control block.

34. A calibration apparatus in a communication system, comprising:
a reference signal generator for generating a reference signal;
a first transmission module for upconverting the reference signal to a Radio Frequency (RF) signal;
a first switch for switching the RF signal;
a combiner and distributor for distributing the switched signal to signal reception paths;
a plurality of reception modules for downconverting the distributed signals to baseband signals; and
a calibrator for acquiring reception calibration vectors using the baseband signals.

35. The calibration apparatus of claim 34, wherein the communication system comprises a time-division scheme.

36. The calibration apparatus of claim 34, wherein the calibrator performs reception calibration by applying the reception calibration vectors to beamforming coefficients for received signals.

37. The calibration apparatus of claim 34, further comprising a plurality of transmission control blocks for receiving signals from the reception modules in reception mode.

38. The calibration apparatus of claim 37, further comprising a switch for switching a signal received from a transmission port of a first transmission control block connected to a first transmission module to the combiner and distributor.

39. The calibration apparatus of claim 38, further comprising a switch for sequentially switching a signal received from the transmission port of the first transmission control block to reception ports of the plurality of transmission control blocks.

40. A calibration apparatus in a communication system, comprising:
a reference signal generator for generating a first reference signal;
a first transmission module for upconverting the first reference signal to a Radio Frequency (RF) signal;
a first coupler for coupling the RF signal;
a combiner and distributor for distributing the coupled signal to reception modules except for a first reception module sharing the same antenna with the first transmission module;
a plurality of couplers for coupling the distributed signals;
the reception modules for downconverting the coupled signals to the baseband signals; and
a calibrator for acquiring a first calibration signal using the baseband signals.

41. The calibration apparatus of claim 40, wherein the communication system comprises a time-division scheme.

42. The calibration apparatus of claim 40, further comprising:
a plurality of reference signal generators for generating second reference signals;
a plurality of transmission modules except for the first transmission module, for upconverting the second reference signals to RF signals;
a plurality of couplers for coupling the RF signals;
a combiner and distributor for combining the coupled signals;
a plurality of first couplers for coupling the combined signal;
the first reception module for downconverting the coupled signal to a baseband signal; and
a calibrator for acquiring a second calibration signal using the baseband signal.

43. The calibration apparatus of claim 42, further comprising:
a reference signal generator for generating a third reference signal;
a second transmission module for upconverting the third reference signal to an RF signal;
a second coupler for coupling the RF signal;
a combiner and distributor for distributing the coupled signal to reception modules except for a second reception mode sharing the same antenna with the second transmission module;
a plurality of couplers for coupling the distributed signals;
a plurality of reception modules for downconverting the coupled signals to baseband signals; and
a calibrator for acquiring a third calibration signal using the baseband signals.

44. The calibration apparatus of claim 43, further comprising:
a plurality of transmission control blocks connected to the transmission modules and the reception modes, for operating in one of transmission mode and reception mode;
a first switch connected to a first coupler and a second switch;
the second switch connected to the first switch and the third switch;
the third switch connected to the second switch and a second coupler; and
a combiner and distributor connected to the first, second and third switches and a plurality of couplers.

45. The calibration apparatus of claim 44, wherein to acquire the first calibration signal, the first switch switches a signal received from the first coupler to the second switch, the second switch switches the signal received from the first switch to the combiner and distributor, and the third switch switches the signal received from the combiner and distributor to the second coupler.

46. The calibration apparatus of claim 45, wherein the first transmission control block operates in the transmission mode and transmission control blocks except for the first transmission control block operate in the reception mode.

47. The calibration apparatus of claim 44, wherein to acquire the second calibration signal, the first switch switches a signal received from the second switch to the first coupler, the second switch switches a signal received from the combiner and distributor to the first switch, and the third switch switches a signal received from the second coupler to the combiner and distributor.

48. The calibration apparatus of claim 47, wherein the first transmission control block operates in the reception mode and the transmission control blocks except for the first transmission control block operate in the transmission mode.

49. The calibration apparatus of claim 44, wherein to acquire the third calibration signal, the first switch switches a signal received from the combiner and distributor to the first coupler, the second switch switches a signal received from the third switch to the combiner and distributor, and the third switch switches a signal received from the second coupler to the second switch.

50. The calibration apparatus of claim 49, wherein the second transmission control block operates in the transmission mode and transmission control blocks except for the second transmission control block operate in the reception mode.

51. The calibration apparatus of claim 44, wherein the calibrator calculates a factor using the first and third calibration signals, for calculating a value of the first reference transmission and reception path, calculates the value of the first reference transmission and reception path by multiplying the factor by the second calibration signal, acquires transmission calibration vectors by dividing the first calibration signal by the value of the first reference transmission and reception path, and acquires reception calibration vectors by dividing the second calibration signal by the value of the first reference transmission and reception path.

52. The calibration apparatus of claim 51, wherein the calibrator acquires the transmission and reception vectors by eliminating coupler characteristics.

53. The calibration apparatus of claim 51, wherein the calibrator performs transmission calibration by applying the transmission calibration vectors to beamforming coefficients for transmission signals.

54. The calibration apparatus of claim 51, wherein the calibrator performs reception calibration by applying the reception calibration vectors to beamforming coefficients for received signals.
